(19) United States
(12) Patent Application Publication
(10) Pub. No.: US 2019/0131617 A1
(43) Pub. Date: May 2, 2019

(54) ANODE FOR LITHIUM METAL BATTERY, METHOD FOR MANUFACTURING SAME, AND LITHIUM METAL BATTERY COMPRISING SAME

(71) Applicants: LG CHEM, LTD., Seoul (KR); POSTECH ACADEMY-INDUSTRY FOUNDATION, Pohang-si (KR)

(72) Inventors: Kyoung Ho AHN, Daejeon (KR); Byoung Woo KANG, Pohang-si (KR); Chul Haeng LEE, Daejeon (KR); Solji PARK, Daejeon (KR); Min Kyu KIM, Pohang-si (KR); Won Tae LEE, Pohang-si (KR)

(73) Assignees: LG CHEM, LTD., Seoul (KR); POSTECH ACADEMY-INDUSTRY FOUNDATION, Pohang-si (KR)

(21) Appl. No.: 16/235,312

(22) Filed: Dec. 28, 2018

Related U.S. Application Data
(63) Continuation of application No. PCT/KR2017/015600, filed on Dec. 28, 2017.

(30) Foreign Application Priority Data
Dec. 28, 2016 (KR) 10-2016-0180723
Dec. 27, 2017 (KR) 10-2017-0180971

(51) Int. Cl. H01M 4/134; H01M 10/052; H01M 4/38; H01M 4/36; H01M 4/62; H01M 4/66; H01M 10/0568; H01M 4/04; H01M 4/1395

(52) U.S. Cl. CPC H01M 4/134; H01M 10/052; H01M 4/382; H01M 4/366; H01M 4/623; H01M 2004/027; H01M 10/0568; H01M 4/628; H01M 4/0402; H01M 4/1395; H01M 4/661

(57) ABSTRACT

A negative electrode for a lithium metal battery, a method for manufacturing the same, and a lithium metal battery having the same. Formation of lithium dendrite may be prevented by forming a dielectric layer on the surface of lithium metal, and thus improve lifespan characteristics and electrochemical performance when applied to a lithium metal battery.

### CROSS REFERENCE TO RELATED APPLICATIONS

This application is a Continuation-in-Part of PCT International Application No. PCT/KR2017/015600, filed on Dec. 28, 2017, which claims priority under 35 U.S.C. 119(a) to Patent Application No. 10-2016-0180723, filed in Republic of Korea on Dec. 28, 2016, and Patent Application No. 10-2017-0180971, filed in Republic of Korea on Dec. 27, 2017, all of which are hereby expressly incorporated by reference into the present application.

### TECHNICAL FIELD

The present invention relates to a negative electrode for a lithium metal battery capable of preventing formation and growth of lithium dendrite generated during charge and discharge of a lithium metal battery, a method for preparing the same, and a lithium metal battery including the same.

### BACKGROUND ART

A lithium metal battery means, unlike a lithium ion battery, a battery using lithium metal as a negative electrode material. Lithium metal as a negative electrode material has been highly expected as an ideal negative electrode material due to having high theoretical capacity (3800 mAh/g) and low oxidation-reduction voltage (−3.040 V vs standard hydrogen voltage), and considerable studies have actually been progressed.

However, lithium metal used as a negative electrode material of a lithium metal battery has largely two problems.

First, when lithium ions are collected on a lithium metal surface during charge and discharge, they grow in a dendrite form ultimately meeting a positive electrode material causing a short circuit. Such a short circuit causes, as well as rapid energy loss, a major problem in stability such as explosion in extreme cases.

Second is a low Columbic efficiency problem. While being exposed to an electrolyte, lithium metal forms a solid electrolyte interface (SEI) by reacting with the electrolyte, and due to consistently formed dendrite-type growth, unexposed lithium metal reacts by being consistently exposed to the electrolyte leading to a problem of consuming lithium ions.

Dendrite formation, a fundamental cause of two such problems, is caused by a difference in the concentration gradient of cations and anions occurring on the lithium metal surface on which lithium ions are collected, and a very large electric field formed thereby.

Due to an externally applied electric field, anions are concentrated on a positive electrode while cations cumulate on a negative electrode surface, which forms space charge on the negative electrode surface due to insufficient anions. By the space charge formed as above forming a very large electric field on the negative electrode, instability at the negative electrode surface and ultimately dendrite-type growth are caused.

Accordingly, in order to enhance stability and performance of a lithium metal battery, technologies capable of preventing formation and growth of lithium dendrite formed on a lithium metal-formed negative electrode during charge and discharge have been required.

### PRIOR ART DOCUMENTS

### Patent Documents

(Patent Document 1) Korean Patent Application Laid Open Publication No. 2009-0103010, “Electrode assembly and lithium secondary battery provided with the same”

### DISCLOSURE

### Technical Problem

As a result of extensive studies in view of the above, the inventors of the present invention have identified that lithium dendrite formation and growth may be suppressed when a dielectric material is coated on a surface of lithium metal forming a negative electrode of a lithium metal battery, and have completed the present invention.

Accordingly, an aspect of the present invention provides a negative electrode for a lithium metal battery including lithium metal having the surface coated with a dielectric layer to prevent lithium dendrite formation and growth.

Another aspect of the present invention provides a method for preparing a negative electrode for a lithium metal battery including lithium metal having the surface coated with a dielectric layer to prevent lithium dendrite formation and growth.

Still another aspect of the present invention provides a lithium metal battery including a negative electrode for a lithium metal battery including lithium metal having the surface coated with a dielectric layer to prevent lithium dendrite formation and growth.

### Technical Solution

According to an aspect of the present invention, there is provided a negative electrode for a lithium metal battery including lithium metal, and a dielectric layer coated on a surface of the lithium metal.

Herein, the dielectric layer may include a dielectric material and a binder, and may further include a lithium salt and a plasticizer.

The dielectric material may be one or more types selected from the group consisting of BaTiO₃, (Ba, Sr)TiO₃, PbTiO₃, LiNbO₃, Pb(Zr, Ti)O₃ and amorphous V₂O₅.

In addition, the negative electrode for a lithium metal battery further includes a current collector, and the lithium metal may be located on the current collector.

The current collector may be one type selected from the group consisting of Cu, steel use stainless (SUS) and Ni.

According to another aspect of the present invention, there is provided a lithium metal battery including the negative electrode.

According to still another aspect of the present invention, there is provided a method for preparing a negative electrode for a lithium metal battery including (S1) forming slurry by mixing a dielectric material, a binder and a solvent; (S2) coating the slurry on a surface of lithium metal; and (S3) drying the surface-coated lithium metal.

### Advantageous Effects

A negative electrode for a lithium metal battery according to the present invention can suppress formation and growth of lithium dendrite by reducing a strong electric field formed on a lithium metal surface due to a dielectric material included in a dielectric layer coated on the lithium metal surface.

In addition, when the dielectric layer is formed in a polymer electrolyte matrix form, the polymer electrolyte matrix performs a role of a single ionic conductor, and the effect of suppressing formation and growth of lithium dendrite can be maximized.

By suppressing formation and growth of lithium dendrite in a negative electrode for a lithium metal battery including a dielectric layer as above, lifetime and electrochemical performance of a lithium metal battery can be enhanced.

A lithium metal battery according to the present invention can be widely used in industries requiring the same, for example, portable devices such as mobile phones, notebook computers or digital cameras, and electric vehicle fields such as hybrid electric vehicles (HEV).

### DESCRIPTION OF DRAWINGS

FIG. 1 is a graph presenting results of evaluating lifetime performance of a negative electrode including a dielectric layer including a dielectric material (BaTiO₃) prepared in Example 1, and a lithium metal negative electrode of Comparative Example 1.

FIG. 2 is a graph presenting results of evaluating lifetime performance of a negative electrode including a dielectric layer including a dielectric material-polymer electrolyte matrix prepared in Example 2, and a lithium metal negative electrode of Comparative Example 1.

FIG. 3 is a graph presenting results of evaluating lifetime performance of negative electrodes each prepared in Example 2, Comparative Example 1 and Comparative Example 2.

### BEST MODE

Hereinafter, the present invention will be described in more detail in order to illuminate the present invention.

Terms or words used in the present specification and the claims are not to be interpreted limitedly to common or dictionary meanings, and shall be interpreted as meanings and concepts corresponding to technological ideas of the present disclosure based on a principle in which the inventors may suitably define the concepts of terms in order to describe the invention in the best possible way.

Negative Electrode for Lithium Metal Battery

The present invention provides a negative electrode for a lithium metal battery including lithium metal, and a dielectric layer coated on a surface of the lithium metal.

Generally, a cause of lithium dendrite being formed and growing on a lithium metal surface in a lithium metal battery is a strong electric field formed on the lithium metal surface.

A dielectric material included in the dielectric layer according to the present invention has, with respect to the electric field formed on the lithium metal surface, polarity in a direction reducing intensity of the electric field, and as a result, may prevent or suppress formation and growth of lithium dendrite by reducing the total electric field. In addition, by the dielectric material that has polarity in a direction reducing intensity of the electric field attracting lithium ions, even lithium ion deposition may also be obtained.

The dielectric layer according to the present invention may include a dielectric material and a binder, and in addition thereto, may further include a lithium salt and a plasticizer. When the dielectric layer includes a dielectric material, a binder, a lithium salt and a plasticizer, a dielectric material-polymer electrolyte matrix form formed by mixing the dielectric material and the polymer electrolyte may be obtained.

The dielectric material may be one or more types selected from the group consisting of BaTiO₃, (Ba, Sr)TiO₃, PbTiO₃, LiNbO₃, Pb(Zr, Ti)O₃ and amorphous V₂O₅, but is not limited thereto, and one or more types of dielectric materials selected from the group consisting of ferroelectric materials, paraelectric materials, pyroelectric materials and piezoelectric materials may be widely used.

The binder performs a role of crosslinking constituents forming the dielectric layer to have the dielectric layer be actually formed. The dielectric layer formed as above may enhance lifetime performance of a lithium metal battery.

The binder may be one or more types selected from the group consisting of polyvinylidene fluoride (PVDF), polyvinylidene fluoride-co-hexafluoro propylene (PVDF-HFP), polyethylene oxide (PEO), polyacrylonitrile (PAN), polymethyl methacrylate (PMMA) and polyvinyl chloride (PVC).

The binder may be included in 5 parts by weight to 1000 parts by weight with respect to 100 parts by weight of the dielectric material. When the binder is included in less than 5 parts by weight, mechanical strength of the dielectric layer may decrease, and when included in greater than 1000 parts by weight, ionic conductivity decreases, and the role as a dielectric layer may be reduced.

In addition, the dielectric layer may include a dielectric material, a binder, lithium salt as an electrolyte salt, and a plasticizer. Herein, the dielectric layer may be formed in a dielectric material-polymer electrolyte matrix form formed by mixing the dielectric material and the polymer electrolyte. The dielectric material-polymer electrolyte matrix has pores formed therein, and a body of the matrix is formed with a gel polymer.

In the dielectric layer having a dielectric material-polymer electrolyte matrix form, the dielectric material reduces intensity of an electric field as described above suppressing formation and growth of lithium dendrite, and in addition thereto, the effect of suppressing the formation and growth of lithium dendrite may be maximized by the dielectric material-polymer electrolyte matrix performing a role of a single ionic conductor.

Particularly, the dielectric material-polymer electrolyte matrix formed with a gel polymer having pores formed therein abundantly includes Li ions inside the gel polymer matrix as well as inside the pores compared to when dielectric material particles such as BaTiO₃ form a film together with a polymer, and an effect of suppressing lithium dendrite generated during charge may be more enhanced.

Generally, when a single ionic conductor is present on a lithium metal surface, the time of starting to form lithium dendrite may be delayed infinitely, and therefore, lithium dendrite formation and growth may be suppressed when the dielectric material-polymer electrolyte matrix-type dielectric layer is coated on the lithium metal.

The lithium salt may be one or more types selected from the group consisting of LiPF₆, LiCIO₄, LiBF₄, LiAsF₆ and LiCF₃SO₃, but is not limited thereto, and lithium salts that may be used for forming a polymer electrolyte may be widely used.

The lithium salt may be included in 50 parts by weight to 150 parts by weight with respect to 100 parts by weight of the dielectric material. When the lithium salt is included in less than 50 parts by weight, the polymer electrolyte matrix may not be formed, and when included in greater than 150 parts by weight, the amount of residual lithium salt increases after forming the polymer electrolyte matrix declining battery performance.

The plasticizer may be one or more types selected from the group consisting of ethylene carbonate (EC), propylene carbonate (PC), dimethyl carbonate (DMC), diethyl carbonate (DEC), dimethoxyethane (DME) and diethoxyethane (DEE).

The plasticizer may be included in 500 parts by weight to 1500 parts by weight with respect to 100 parts by weight of the dielectric material. When the plasticizer is included in less than 500 parts by weight, the polymer electrolyte matrix may not be formed, and when included in greater than 1500 parts by weight, the amount of residual lithium salt increases after forming the polymer electrolyte matrix declining battery performance.

The dielectric layer may have a thickness of 0.1 to 9.9 μm, preferably 1.0 to 7.0 μm, more preferably 2.0 to 5.0 μm. If the thickness is less than the above range, the effect of preventing or suppressing for the growth of lithium dendrite. If the thickness is more than the above range, the dielectric layer acts as resistance so that battery performance may decline.

The negative electrode for a lithium metal battery according to the present invention may further include a current collector, and specifically, the negative electrode for a lithium metal battery may include a current collector; lithium metal located on the current collector; and a dielectric layer coated on a surface of the lithium metal.

The current collector may be one type selected from the group consisting of Cu, steel use stainless (SUS) and Ni, but is not limited thereto, and current collectors that may be used in a negative electrode for a lithium metal battery may be widely used.

Method for Preparing Negative Electrode for Lithium Metal Battery

The present invention also relates to a method for preparing a negative electrode for a lithium metal battery as described above, which may include (S1) forming slurry by mixing a dielectric material, a binder and a solvent; (S2) coating the slurry on a surface of lithium metal; and (S3) drying the surface-coated lithium metal.

In the step (S1), slurry for preparing a dielectric layer may be formed.

The slurry for preparing a dielectric layer may include a dielectric material and a binder, and in addition thereto, may further include a plasticizer and a lithium salt. Herein, the content and specific examples of the dielectric material, the binder, the lithium salt and the plasticizer are as described above.

In addition, the solvent used in forming the slurry may be one or more types selected from the group consisting of N-methyl-2-pyrrolidone (NMP), acetone, ethanol, tetrahydrofuran (THF), dimethyl acetamide (DMAc) and toluene.

In the step (S2), the slurry prepared in the step (S1) may be uniformly coated on a surface of lithium metal.

Herein, the coating may be carried out using one or more types of methods selected from the group consisting of casting, electrochemical coating, deposition and spin coating, however, the coating is not limited thereto as long as it is a method capable of uniformly coating the slurry on a surface of lithium metal.

In the step (S3), the slurry coated on the lithium metal may be dried to form a dielectric layer, and the solvent may be removed by drying.

Herein, the dielectric layer may be formed by vacuum drying under a temperature of 50° C. to 70° C. When the vacuum drying temperature is lower than 50° C., the solvent may not be completely dried, and when the temperature is higher than 70° C., physical properties of the materials forming the dielectric layer, for example, the plasticizer and the like, may change.

Lithium Metal Battery

The present invention also relates to a lithium metal battery including a negative electrode for a lithium metal battery as described above.

In the lithium metal battery, a negative electrode and a positive electrode are disposed to face each other, and an electrolyte is provided therebetween. Herein, the negative electrode may include lithium metal and a dielectric layer coated on a surface of the lithium metal.

In the negative electrode for a lithium metal battery, by coating a dielectric layer including a dielectric material on a surface of lithium metal, a lithium cation concentration is controlled on the lithium metal surface during charge and discharge, and as a result, a problem of space charge formation is reduced preventing the generation of a large electric field in the negative electrode, and as a result, formation and growth of lithium dendrite may be prevented.

In addition, when the dielectric layer has a polymer electrolyte matrix form including a dielectric material, a lithium salt and a plasticizer, the polymer electrolyte matrix performs a role of a single ionic conductor and thereby maximizes the effect of suppressing lithium dendrite formation and growth.

Accordingly, the lithium metal battery according to the present invention may have enhanced lifetime and electrochemical performance by preventing formation and growth of lithium dendrite.

Hereinafter, preferred examples will be provided in order to illuminate the present invention, however, the following examples are for illustrative purposes only, and it will be obvious to those skilled in the art that various changes and modifications may be made within the scope and technological ideas of the present invention, and such changes and modifications also belong to the scope of the attached claims.

In the following examples and comparative examples, negative electrodes were prepared in the compositions as described in the following Table 1.

TABLE 1

| Unit: | Dielectric Layer | | | | | | | | | | |
|---|---|---|---|---|---|---|---|---|---|---|---|
| Parts by | Dielectric | | | | Lithium | | | | | | Thickness |
| Weight | Material | | Binder | | Salt | | Plasticizer | | Solvent | | (μm) |
| Example 1 | BaTiO₃ | 100 | PVDF | 23 | — | — | — | — | NMP | 2 | 5 |
| Example 2 | BaTiO₃ | 100 | PVDF- | 625 | LiPF₆ | 100 | EC/PC | 525/525 | THF | 0.45 | 5 |
| | | | HFP | | | | | | | | |
| Example 3 | BaTiO₃ | 100 | PVDF- | 625 | LiPF₆ | 100 | EC/PC | 525/525 | THF | 0.45 | 1.5 |
| | | | HFP | | | | | | | | |
| Example 4 | BaTiO₃ | 100 | PVDF- | 625 | LiPF₆ | 100 | EC/PC | 525/525 | THF | 0.45 | 7 |
| | | | HFP | | | | | | | | |
| Comparative | No Dielectric Layer | | | | | | | | | | |
| Example 1 | | | | | | | | | | | |
| Comparative | BaTiO₃ | 100 | PVDF- | 625 | — | — | EC/PC | 525/525 | THF | 0.45 | 5 |
| Example 2 | | | HFP | | | | | | | | |
| Comparative | BaTiO₃ | 100 | PVDF- | 625 | LiPF₆ | 100 | EC/PC | 525/525 | THF | 0.45 | 0.08 |
| Example 3 | | | HFP | | | | | | | | |
| Comparative | BaTiO₃ | 100 | PVDF- | 625 | LiPF₆ | 100 | EC/PC | 525/525 | THF | 0.45 | 11 |
| Example 4 | | | HFP | | | | | | | | |

### Example 1: Preparation of Lithium Metal Negative Electrode Including Dielectric Layer Including Dielectric Material

1-1. Slurry Preparation

Slurry was prepared by mixing a dielectric material, a binder and a solvent. BaTiO₃ was used as the dielectric material, polyvinylidene fluoride (PVDF) was used as the binder, and N-methyl-2-pyrrolidone (NMP) was used as the solvent.

1-2. Slurry Coating

The slurry was uniformly coated on a lithium metal surface using a casting method.

1-3. Drying

The slurry-coated lithium metal was vacuum dried at 60° C. to form a dielectric layer on the lithium metal, and a negative electrode was prepared.

### Example 2: Preparation of Lithium Metal Negative Electrode Including Dielectric Layer Including Dielectric Material and Polymer Electrolyte Matrix

2-1. Slurry Preparation

Slurry was prepared by mixing a dielectric material, a binder, a lithium salt, a plasticizer and a solvent. BaTiO₃ was used as the dielectric material, polyvinylidene fluoride-co-hexafluoro propylene (PVDF-HFP) was used as the binder, LiPF₆ was used as the lithium salt, ethylene carbonate/propylene carbonate (EC/PC), a mixture of EC and PC, or propylene carbonate (PC) was used as the plasticizer, and N-methyl-2-pyrrolidone (NMP) was used as the solvent.

Specifically, the PVDF-HF was introduced to THF, the result was mixed to prepare a mixture, the EC/PC prepared in the same weight ratio of EC and PC was added to the mixture, and the BaTiO₃ was mixed thereto to prepare a dielectric material-polymer electrolyte matrix formed by mixing the dielectric material and the polymer electrolyte.

2-2. Slurry Coating

The dielectric material-polymer electrolyte matrix was coated on a lithium metal surface, and uniformly coated using a spin coating method.

2-3. Drying

The dielectric material-polymer electrolyte matrix-coated lithium metal was vacuum dried at 60° C. to form a dielectric layer on the lithium metal surface, and a negative electrode was prepared.

### Example 3 and 4: Preparation of Lithium Metal Negative Electrode

A negative electrode was prepared in the same manner as in Example 2, except that the thickness of the dielectric layer was different.

### Comparative Example 1: Preparation of Lithium Metal Negative Electrode

A lithium metal negative electrode having no dielectric layer coated on the surface was prepared.

### Comparative Example 2: Preparation of Lithium Metal Negative Electrode Including Dielectric Layer Including Dielectric Material and Polymer Matrix

A negative electrode was prepared in the same manner as in Example 2, except that the lithium salt was not used, and a dielectric material-polymer matrix was coated on the metal surface.

### Comparative Example 3 and 4: Preparation of Lithium Metal Negative Electrode

A negative electrode was prepared in the same manner as in Example 2, except that the thickness of the dielectric was different.

### Experimental Example 1: Experiments of Lifetime Performance Evaluation

For the negative electrodes each prepared in Examples 1 and 2, lifetime performance was evaluated by charging and discharging with current density of 1 mA/cm² in the unit of 3 hours.

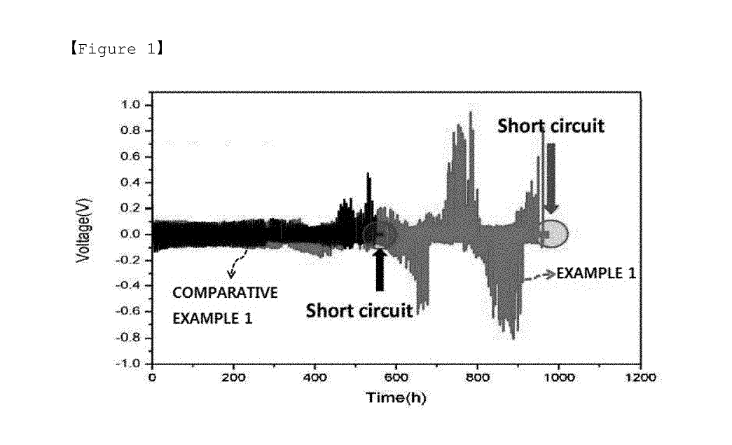

FIG. 1 is a graph presenting results of evaluating lifetime performance of the lithium metal negative electrode including a dielectric layer including a dielectric material (BaTiO₃) prepared in Example 1, and the lithium metal negative electrode of Comparative Example 1. Herein, lifetime performance was evaluated by charging and discharging with current density of 1 mA/cm² in the unit of 3 hours.

Referring to FIG. 1, it was seen that the negative electrode including a dielectric layer including a dielectric material (BaTiO₃) of Example 1 had enhanced lifetime performance compared to the lithium metal negative electrode that does not include a dielectric layer of Comparative Example 1.

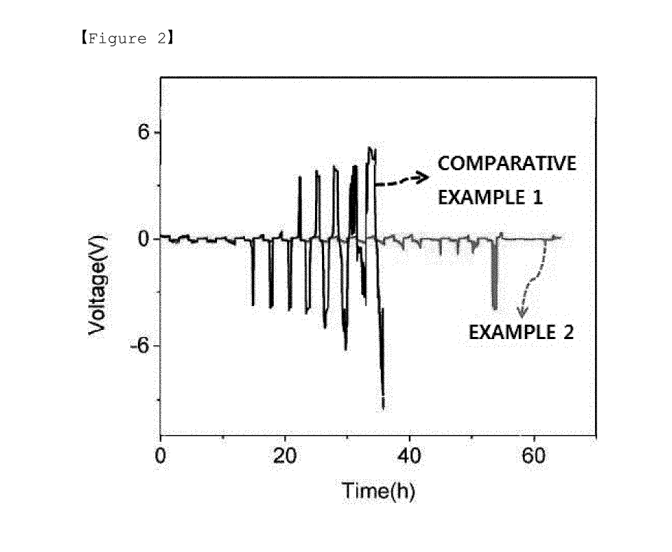

FIG. 2 is a graph presenting results of evaluating lifetime performance of the lithium metal negative electrode including a dielectric layer including a dielectric material-polymer electrolyte matrix prepared in Example 2, and the lithium metal negative electrode of Comparative Example 1. Herein, lifetime performance was evaluated by charging and discharging with current density of 1 mA/cm² in the unit of 1.5 hours.

Referring to FIG. 2, it was seen that the lithium metal negative electrode including a dielectric layer including a dielectric material-polymer electrolyte matrix exhibited more enhanced lifetime performance and electrochemical performance compared to the lithium metal negative electrode that does not include a dielectric layer of Comparative Example 1.

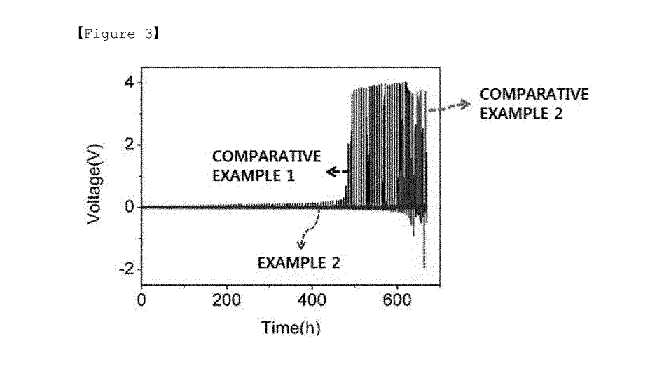

FIG. 3 is a graph presenting results of evaluating lifetime performance of the negative electrodes each prepared in Example 2, Comparative Example 1 and Comparative Example 2. Herein, lifetime performance was evaluated by charging and discharging with current density of 1 mA/cm² in the unit of 3 hours.

Referring to FIG. 3, it was seen that lifetime performance of the lithium metal negative electrode having a dielectric layer including a dielectric material-polymer electrolyte matrix formed of Example 2 was stably enhanced.

Particularly, when comparing Example 2 and Comparative Example 2, the negative electrode was coated with a dielectric material-polymer electrolyte matrix in Example 2, and the negative electrode was coated with a dielectric material-polymer matrix in Comparative Example 2, and it was seen that lifetime performance was enhanced in Example 2 that is a negative electrode coated with a dielectric material-polymer electrolyte matrix.

### Experimental Example 2: Experiments of Lifetime Performance Evaluation

Lifetime performances were evaluated for the negative electrodes respectively produced from Examples 2, 3, 4 and Comparative Example 1, 3, 4.

The following Table 2 is the evaluation result of lifetime performance for the lithium metal negative electrodes comprising the dielectric layers with dielectric material (BaTiO₃) produced from Examples 2, 3, 4 and Comparative Examples 3, 4 and for the lithium metal negative electrode of Comparative Example 1. Herein, lifetime performance was evaluated by charging and discharging with current density of 1 mA/cm² in the unit of 3 hours and by measuring cycle number of occurring short.

TABLE 2

| Unit: | Thickness of | Cycle number |
|---|---|---|
| Parts by | dielectric layer | [based on the |
| Weight | (μm) | occurrence of short] |
| Example 2 | 5 | 990 |
| Example 3 | 1.5 | 1012 |
| Example 4 | 7 | 910 |
| Comparative | 5 | 540 |
| Example 1 | | |
| Comparative | 0.08 | 650 |
| Example 3 | | |
| Comparative | 11 | 720 |
| Example 4 | | |

Referring to Table 2, it was seen that lifetime performance of Comparative examples 3 and 4 having the dielectric layer of thin thickness was declined besides Examples 2, 3 and 4.

Hereinbefore, preferred examples of the present invention have been described in detail, however, the scope of a right of the present invention is not limited thereto, and various modifications and improvements made by those skilled in the art using the basic concept of the present invention defined in the attached claims also belong to the scope of a right of the present invention.

1. A negative electrode for a lithium metal battery comprising:
lithium metal; and
a dielectric layer coated on a surface of the lithium metal.

2. The negative electrode for a lithium metal battery of claim 1, wherein the dielectric layer includes a dielectric material and a binder.

3. The negative electrode for a lithium metal battery of claim 2, wherein the dielectric layer includes the binder in 5 parts by weight to 1000 parts by weight with respect to 100 parts by weight of the dielectric material.

4. The negative electrode for a lithium metal battery of claim 2, wherein the dielectric material is one or more types selected from the group consisting of BaTiO₃, (Ba, Sr)TiO₃, PbTiO₃, LiNbO₃, Pb(Zr, Ti)O₃ and amorphous V₂O₅.

5. The negative electrode for a lithium metal battery of claim 2, wherein the binder is one or more types selected from the group consisting of polyvinylidene fluoride (PVDF), polyvinylidene fluoride-co-hexafluoro propylene (PVDF-HFP), polyethylene oxide (PEO), polyacrylonitrile (PAN), polymethyl methacrylate (PMMA) and polyvinyl chloride (PVC).

6. The negative electrode for a lithium metal battery of claim 2, wherein the dielectric layer further includes a lithium salt as an electrolyte salt, and a plasticizer.

7. The negative electrode for a lithium metal battery of claim 6, wherein the dielectric layer includes the lithium salt in 50 parts by weight to 150 parts by weight and the plasticizer in 500 parts by weight to 1500 parts by weight with respect to 100 parts by weight of the dielectric material.

8. The negative electrode for a lithium metal battery of claim 6, wherein the lithium salt is one or more types selected from the group consisting of LiPF₆, LiCIO₄, LiBF₄, LiAsF₆ and LiCF₃SO₃.

9. The negative electrode for a lithium metal battery of claim 6, wherein the plasticizer is one or more types selected from the group consisting of ethylene carbonate (EC), propylene carbonate (PC), dimethyl carbonate (DMC), diethyl carbonate (DEC), dimethoxyethane (DME) and diethoxyethane (DEE).

10. The negative electrode for a lithium metal battery of claim 1, wherein the dielectric layer has a thickness of 0.1 to 9.9 μm.

11. The negative electrode for a lithium metal battery of claim 1, further comprising a current collector,
wherein the lithium metal is located on the current collector.

12. The negative electrode for a lithium metal battery of claim 11, wherein the current collector is one type selected from the group consisting of Cu, steel use stainless (SUS) and Ni.

13. A lithium metal battery comprising the negative electrode of claim 1.

14. A method for preparing a negative electrode for a lithium metal battery comprising:
(S1) forming slurry by mixing a dielectric material, a binder and a solvent;
(S2) coating the slurry on a surface of lithium metal; and
(S3) drying the surface-coated lithium metal.

15. The method for preparing a negative electrode for a lithium metal battery of claim 14, wherein the solvent is one or more types selected from the group consisting of N-methyl-2-pyrrolidone (NMP), acetone, ethanol, tetrahydrofuran (THF), dimethyl acetamide (DMAc) and toluene.

16. The method for preparing a negative electrode for a lithium metal battery of claim 14, wherein the slurry further includes a plasticizer and a lithium salt.
